(19) United States
(12) Patent Application Publication
(10) Pub. No.: US 2012/0142318 A1
(43) Pub. Date: Jun. 7, 2012

(54) METHOD AND SYSTEM FOR DETERMINING AND MANAGING THE PRESENCE AND AVAILABILITY OF CELLULAR PHONES

(75) Inventor: Shmuel Okon, Hod Hasharon (IL)

(73) Assignee: Shmuel Okon, Hod Hasharon (IL)

(21) Appl. No.: 13/310,982

(22) Filed: Dec. 5, 2011

Related U.S. Application Data
(60) Provisional application No. 61/419,844, filed on Dec. 5, 2010.

(51) Int. Cl. H04W 4/16; H04W 4/12

(52) U.S. Cl. 455/413; 455/414.1

(57) ABSTRACT

The invention provides a method and system for determining the presence and availability of cellular phones, to maximize the number of completed calls. A web server monitors the cell-phone availability status of subscribing users. A software application periodically updates the server with the subscribing user's cellular phone availability status. Upon user request for performing a phone call between cellular phones, the server determines whether the destination cellular phone is a registered user, is present and is available; and performs a cellular phone call only if the destination is available. If the destination is not present or is unavailable, the user may select an action to take. The invention lowers the overload on the network, and only allows initiation only of calls that can be completed. Additionally, the method and system may be used to create a social or business network between available and adjacently located individuals having similar needs.

This application claims priority under 35 U.S.C. §119(e) to U.S. Provisional Application No. 61/419,844, filed Dec. 5, 2010, which is hereby incorporated by reference in its entirety.

### FIELD OF INVENTION

The invention relates generally to mobile communication systems and more particularly, to a method and system for determining the presence and availability of subscribers of cellular networks, in order to maximize the number of completed calls. The method and system may additionally be used for social or business networking.

### BACKGROUND OF INVENTION

Cellular phone service providers only bill a customer for calls that were completed, such that the call was answered by the receiving party or by the receiving party's voice mail. All unanswered calls represent loss of revenue, and waste of the cellular provider's resources, by tying up open communication channels which could be used by others. Often, when a customer cannot reach the receiving party, he will repeatedly redial and fail, since the destination cellular phone is still out of range (“not present” in the cellular network), or unavailable: turned off, busy, or being ignored. This represents maximal waste of resources and revenues, since the caller cannot be billed, and is preventing other users from utilizing the airtime to complete their calls. The caller's line in turn becomes busy with his repeated dialing, preventing others from reaching him.

The need exists for a system and method that would allow a cellular phone provider to maximize the number of completed calls generated, by informing a user when a destination is present within the cellular network, and available to answer a call.

U.S. Pat. No. 7,515,904 to the present inventor, addresses this need, and is incorporated in its entirety herein. The '904 patent discloses a method and system for sending a notification to a user when a previously busy destination became available. The '904 patent suffers from the disadvantage that it requires installation of specialized hardware such as specialized probing cards, upon the control system server designated for detecting whether a destination is available. These specialized probing cards, (such as manufactured by Dialogic Ltd. of Milpitas, Calif., USA), perform constant “sensing” or “probing” of all defined handsets, to determine their availability. This sensing engages the network system and creates a burden. The '904 patent suffers from the disadvantage that the server for detecting availability is located within the cellular provider, thus it is dependent upon the technology used by the cellular provider (such as GSM, CDMA, 4^{th} generation technology); this may differ between various carriers, and even a single carrier may utilize several technologies which must communicate with the server for determining availability. In order to determine availability, communication between various cell providers is necessary and may be difficult to obtain. If changes are required to be made to the hardware or software for determining availability, these changes must be introduced repeatedly at various locations for each cellular provider.

Additionally, in the '904 patent, an initial call must fail before the system is activated to track the availability and send a notification of renewed availability. It would be desirable to be able to determine availability of a destination before an initial call has failed, thus maximizing revenues by avoiding an initial failed call.

In the present invention, no specialized hardware is necessary to track the presence or availability of a destination, and no call failure is necessary before activation of the presence and availability tracking system. It is the object of the present invention to provide a system and method which overcomes the above drawbacks. These and other objects will become more apparent in view of the Detailed Description that follows.

### SUMMARY OF THE INVENTION

The invention provides a call-management-service for cellular phones (particularly smart phones), implemented via a dedicated web server. The invention notifies a caller efficiently and rapidly when a destination is either unreachable or unavailable to answer a call. Moreover, the system can notify a user when a previously unreachable destination has become available. This is achieved at no cost to the underlying conventional network infrastructure, and shortens the time the caller has to wait for an ‘unavailable’ response, from approximately 30 seconds typical of the prior art handshake technique, to only 1-2 seconds using the invention. Initiation of a call only happens in a situation where both parties are present and available. There are no wasted network resources due to incomplete calls.

The invention is implemented using a software application installed on a user's cell phone. The role of the application is management of ingoing and outgoing calls between various subscriber smart phones. In addition, a dedicated web server, running the software of the invention, is connected to the World Wide Web, and is utilized to store subscriber's various parameters and manage the connection among subscribers.

When a user is interested in initiating a call, the application requests and receives information about the presence and availability state of a destination user's cell phone. The application initiates a connection to the server, via an internet protocol. The application handles the exchange of information in a consistent and fluent manner.

The invention thus provides a method for determining the availability of a cellular phone destination, comprising:
maintaining a web server for monitoring the cellular phone availability status of a plurality of subscribing users;
registering a user as a subscribing user;
providing a subscribing user with a software application for periodically updating a web server with the subscribing user's cellular phone availability status;
receiving periodic updates of availability status from the users, and saving the updates upon the web server;
upon user request for performing a phone call between cellular phones, determining whether the destination cellular phone is a registered user and is available, from the updated availability status;
performing a cellular phone call if the destination is available; and allowing a user to select an action if the destination is unavailable.

In some embodiments, in step (f), the action that may be selected if the destination is unavailable, is informing the user when the destination becomes available. Alternatively, in step (f), the action that may be selected if the destination is unavailable, is recording a voice message for delivery to the destination. In another alternative, the action that may be selected if the destination is unavailable, is delivering a notification for delivery to the destination. In such case, the notification may be selected from: a text message, a standardized sound message, or a visual icon of a missed call.

In some embodiments, step (b) of registering a user, further comprises registering a user's profile for networking, and comprises an additional step performed before step (e), of allowing a user to request to match his profile to another user's profile, and to receive the phone number of a matched available user. In such case, the user profile may include one or more of the following: profession, fields of interest, physical address, age, gender, current location, time, profession, sports, dating preferences, and social activities.

The networking may comprise forming of: carpools, social groups, movie clubs, sports teams; for the purpose of dating, and for locating business service providers.

The invention also provides a system for determining the availability of a cellular phone destination, comprising:
a web server running software for registering a subscribing user and for monitoring the cellular phone availability status of a plurality of subscribing users;
a software application for a cellular phone, for periodically updating a web server with the subscribing user's cellular phone availability status;
wherein, upon receiving a user request for performing a phone call between cellular phones, the server is adapted to: determine whether the destination cellular phone is a registered user and is available, from an updated availability status; perform a cellular phone call if the destination is available; and allow a user to select an action if the destination is unavailable.

In the system, the software (a) for registering a subscribing user may comprise software for registering a user's profile for networking, and the web server allows a user to request to match his profile to another user's profile, and to receive the phone number of a matched available user. In such case, the networking may comprise forming of: carpools, social groups, movie clubs, sports teams; for the purpose of dating, and for locating business service providers.

### BRIEF DESCRIPTION OF THE DRAWINGS

The present invention is illustrated by way of example in the figures of the accompanying drawings, in which like references indicate similar elements and in which:

FIG. 1A describes the basic structure of the system, describing relationships between a cellular network, various user cellular phones and a dedicated web server.

FIG. 1B describes the procedure of downloading an application to smart phone, user registration and connecting a new subscriber.

FIG. 2 is a flowchart describing a real time update of the availability of a subscribing smart phone handset, as communicated to the web server.

FIG. 3 describes the process of a call being initiated between subscribers.

FIG. 4 is a flowchart describing action options that a user may request when a destination is not available.

FIG. 5 is a flowchart describing handling a future (deferred) call, performed after a previously unavailable destination has become available to receive a call.

FIG. 6 is a flowchart describing leaving a notification to a destination, such as a “missed call” notification.

FIG. 7 is a flowchart describing leaving a voice message to an unavailable destination.

FIG. 8 is a flowchart for registering or modifying a user's profile parameters on the web server, allowing networking between subscribing users.

FIG. 9 is a flowchart describing social networking between two available subscribers with a common goal or interest.

### DETAILED DESCRIPTION OF THE INVENTION

In the invention, a web server running software of the invention is constantly updated as to the status of all subscribers' handsets. An application is installed on a user's cellular handset, and communicates the handset's availability status to the web server at predetermined intervals. Therefore, when an attempt to initiate a call is made, the caller's phone receives the presence and availability status of the destination immediately from the web server and will only initiate a call (through an ordinary cellular network) if the call can be completed. The call is then initiated using the cellular phone's native dialer. The method proposed herein can guarantee that when attempting to make a call, using the system described, it will always result in success.

In prior art, in order to initiate a conventional call between two subscribers the cellular network had to perform a number of time-consuming and complex operations, such as locating the destination phone within a cell and performing a handshake, which could take approximately 30 seconds of air time. In essence, these actions could have been avoided if the destination was deemed unavailable. In contrast, checking the availability of the destination using the dedicated web server of the invention, and the software application installed upon user's cellular handsets, lasts no more than 1 second. The invention therefore frees the cellular network resources for calls that can be completed, thus maximizing revenues.

The web server follows all subscribers' presence and availability. In the event that a call cannot be completed due to the unavailability of the destination phone, the server enables the caller to choose between:
1. Being notified of the possibility of making the call as soon as caller and destination are both available.
2. Recording a voice message that will be delivered to the destination
3. Leaving a notification for the destination, i.e. “unanswered call”

Voice messages are kept on the web server, including message status (message has been heard or not yet heard, message was deleted etc.). There is an option to manage new and old messages (retrieve a message, save a message, send and receive messages and sort history of messages).

The invention proposed herein differs from other existing solutions that require installation of a customized server within the cellular infrastructure. Such an endeavor requires intensive coordination between various cellular providers, network integrators and various infrastructure equipment suppliers of cellular networks, and would therefore be difficult to implement.

In the present invention, the web server is maintained externally to all cellular networks, thus changes to the hardware or software can be made at a single server without the need to introduce changes to various cellular providers. The specific technology used by the cellular provider is of less relevance than in prior art, since the availability is periodically communicated to the server by the software application upon the handset, thus there is no cross-communication between networks to determine the availability. There is no need to perform “sensing” to determine availability, thus freeing up the cellular network for phone calls that can be completed.

The fact that user availability definitions are kept on an external web server and not in the infrastructure of the cellular network allows for greater flexibility in terms of the number and type of user availability parameters recognized (e.g. cellular phone in “silent state”, user in a meeting, do not disturb, user abroad, etc,) that can be stored on the web server. This could affect the availability of the person receiving the call and/or sending an appropriate message to the destination. This differs from the stringent restrictions imposed by conventional cellular networks.

In one embodiment, a subscriber may define specific parameters controlling from which callers and when he is ready to accept calls. For instance, a subscriber may define himself as unavailable to most callers during a specific time period, yet may define a list of “VIP” people whom he is always willing to accept calls from, even if the phone is set to “meeting” or “silent state”.

The web server also supports adding a personal VIP contact list. The availability of a VIP contact person is constantly monitored and the web server sends a real time indication regarding changes to their status.

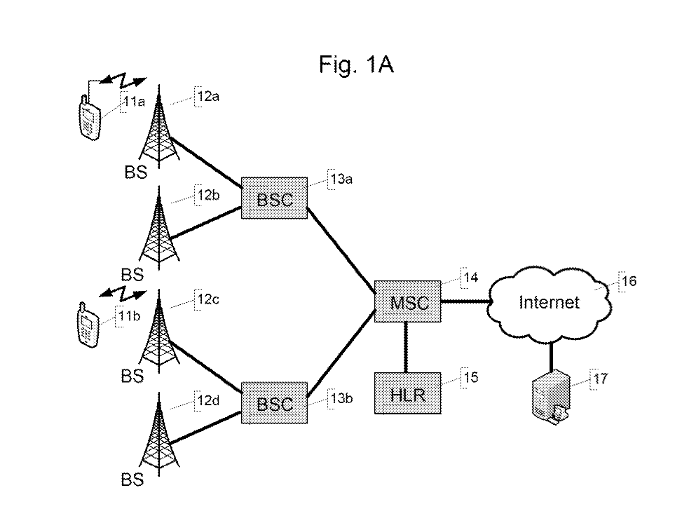

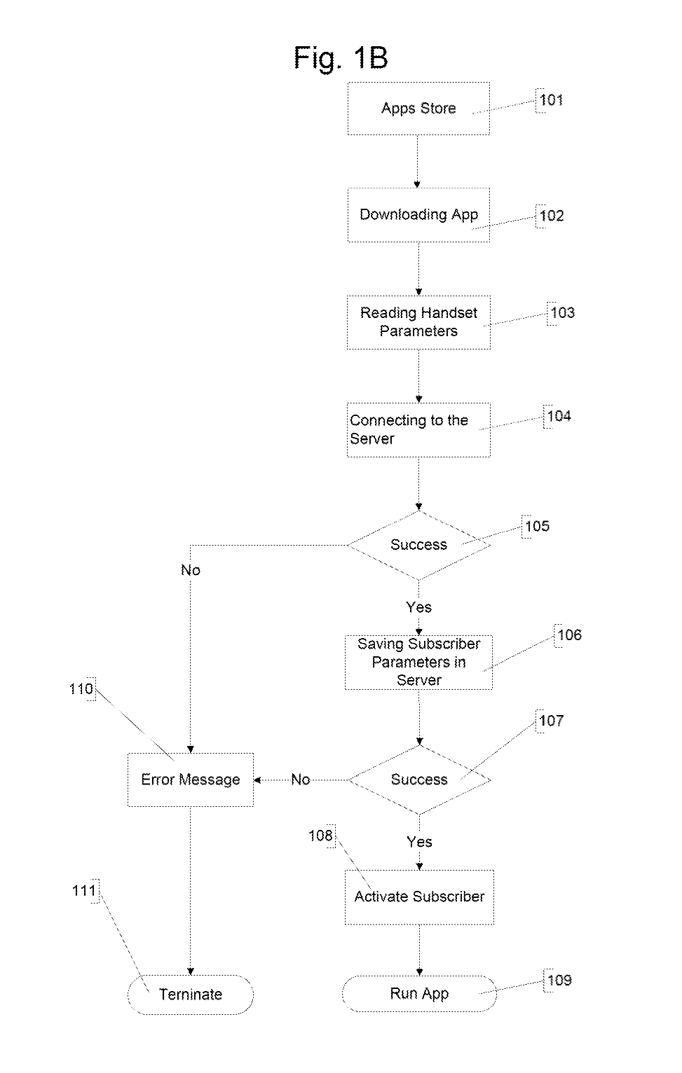

Referring now to FIG. 1A, a high-level diagram is illustrated, of a typical cellular network that includes: Smart Phones (11a, 11b), Base Stations (12a, 12b, 12c, 12d), BSC (Base Station Controllers) (13a, 13b), Mobile Switching Center (MSC) (14), Home Location Register (HLR) (15), Internet Network (16). The dedicated Web Server (17) running software of the invention communicates periodically with smart phones (11a, 11b), and is updated with their availability status.

FIG. 1B describes the process of downloading the application to the smart phones, user registration on the web server, connecting and activating a new subscriber to the service and sending an error message in case of failure.

Referring to FIG. 1B, the process entails the following steps: In step (101), the user locates the software application in an app store available on an online webpage. In step (102), the user downloads the software application to the smart phone handset. In (103), the application reads the handset's relevant operating parameters. In step (104), the software application connects to the dedicated web server of the invention, and sends the handset's parameters to the web server. In (105), the application and web server coordinate validity of the new subscriber's data. If the connection fails, the user is notified through an error message (110), and the operation terminates (111). If the connection is successful (106), user parameters are saved on the server, registration succeeds (107), and the user is added as a new subscriber (108). The application begins to run (109), and update the web server periodically of the availability status of the cellular handset. If the operation failed (107) the user receives an error message (110) and the operation terminates (111).

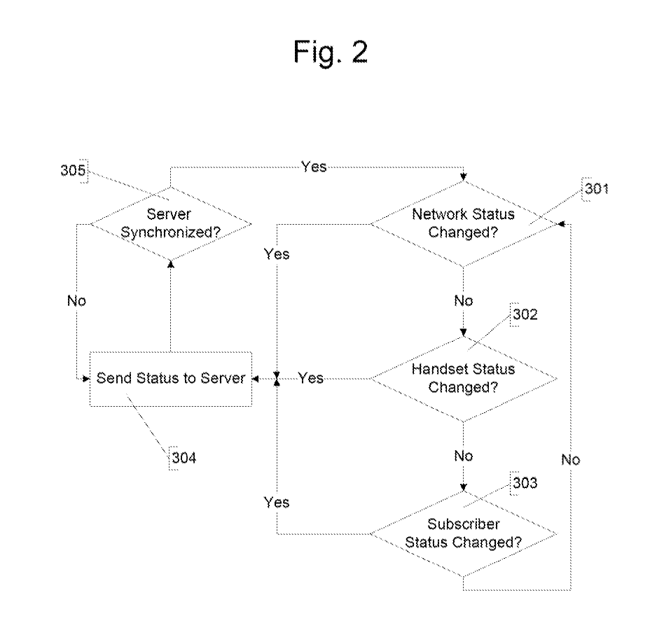

FIG. 2 is a flowchart describing a real time update of the availability of a subscribing smart phone handset, as communicated to the web server.

The steps of the availability update process flow are: The cellular network status may change (301), such as when the network is temporarily unavailable. Alternatively, the handset availability status may change (302), such when the cellular phone is turned off, or is out of range. The subscriber himself may initiate a change in his availability (303), such as when he is entering a business meeting. All such changes are sent by subscribing handsets to the web server (304). The web server receives and synchronizes concurrent network status, handset status and subscriber status (305) and the central updating loop runs periodically (301) to detect a change in the availability of the subscribing handset.

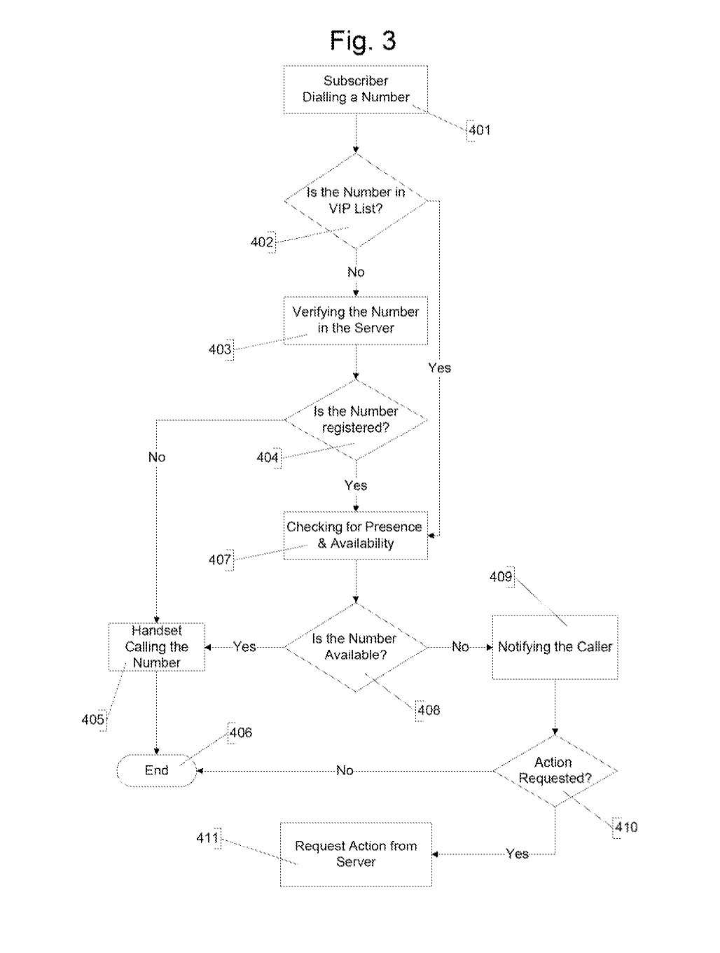

FIG. 3 describes the process of initiating a call between subscribers.

The steps of the process are: A subscriber dials a number (401). If the caller has not defined the destination as a VIP on the caller's VIP list (402), then a check is made by the web server to verify whether the destination number is a registered subscriber (403). If the destination number is not registered on the web server as a subscriber (404), the call is routed through the cellular network with no further checks (405). The process then ends (406). If the destination number is a registered subscriber (404) a check is made to verify the presence of the destination within the range of the cellular network, and the availability of the destination handset (407). If the destination is available (408), the call is routed to the cellular network (405), and the call is completed as a successful call.

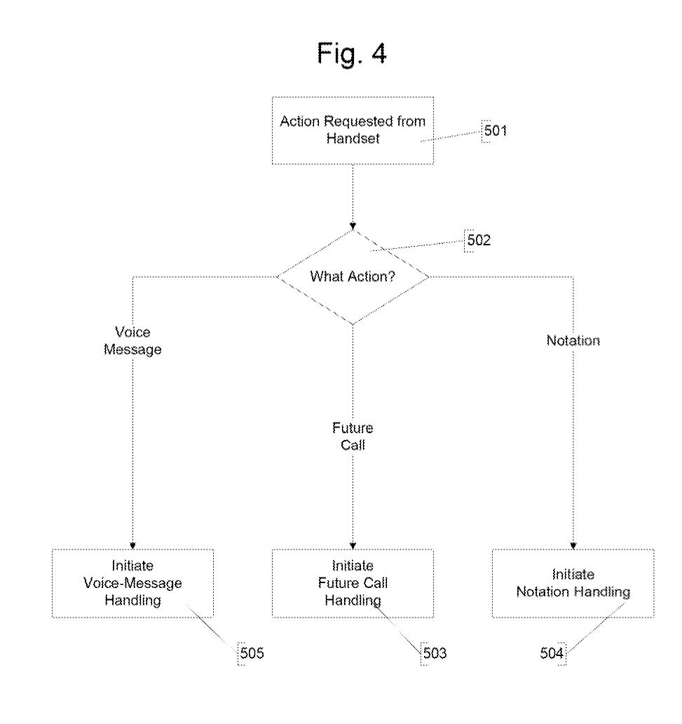

If the destination is not available (408) then the caller is notified (409). If the user requests a further action (410) such as described in relation to FIG. 4, then the action request is sent to the web server for execution (411).

In step (402), if the caller has defined the destination number as a VIP on the caller's VIP list, then steps 403 and 404 (of checking whether the destination is a subscriber) are skipped.

FIG. 4 describes various actions that a user may request when a destination is not available.

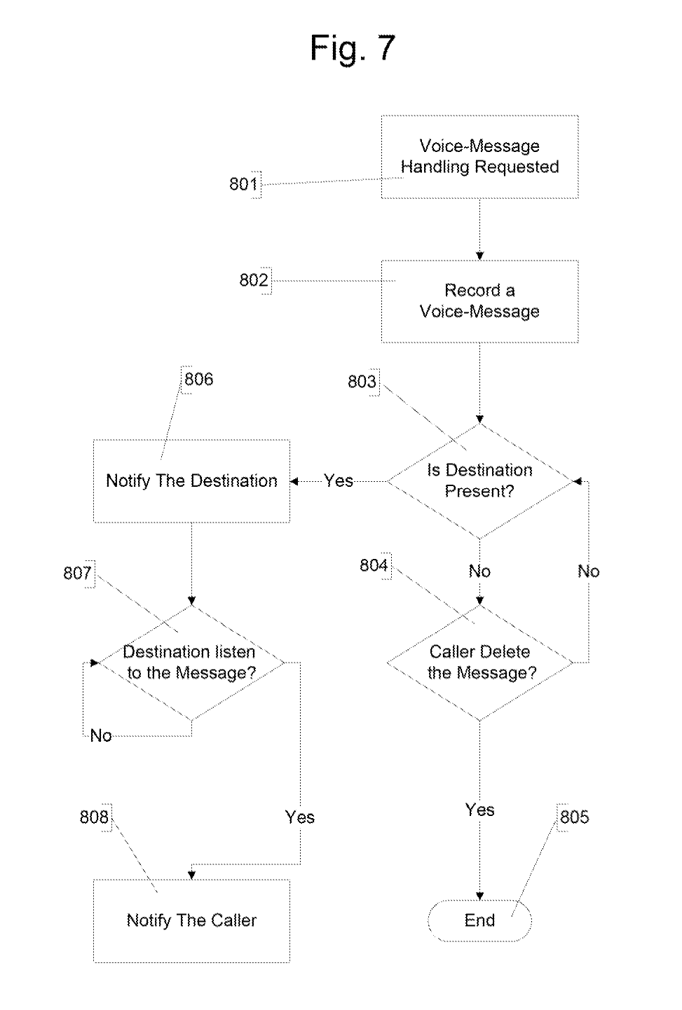

The steps of the process are: The subscribing caller's request is sent to the web server (501). The web server selects (505) what action to initiate according to the caller's request:
Optionally, the caller may record a voice message (505). This is described hereinbelow in relation to FIG. 7.

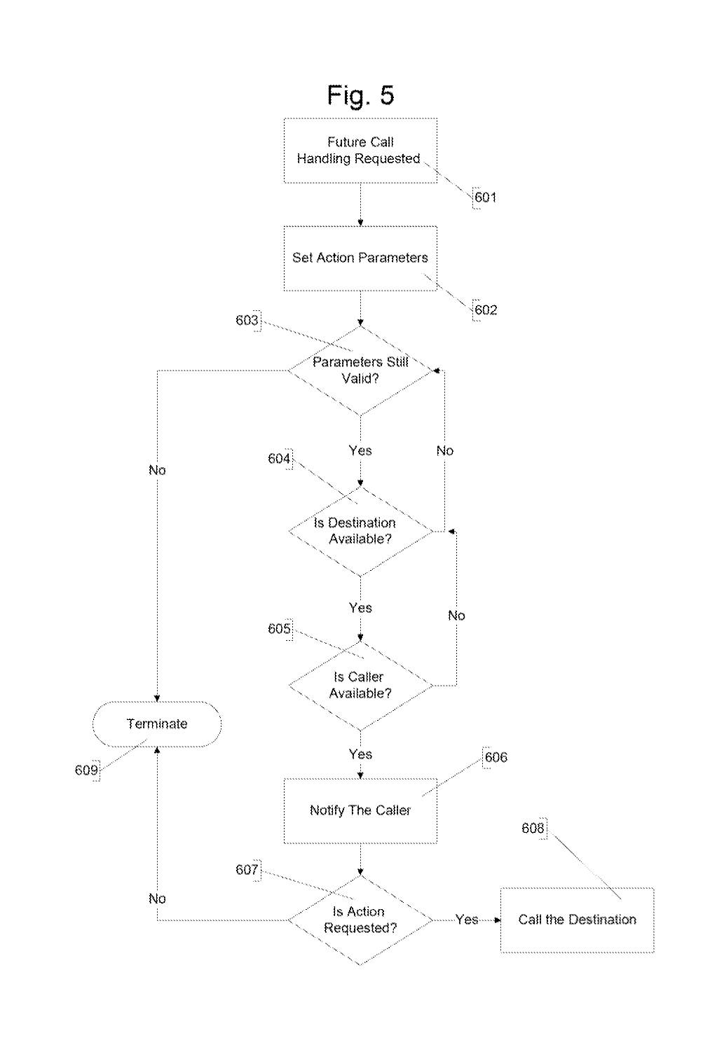

Alternatively, a caller may request to be informed when the destination becomes available and may then initiate a future call (503). This is described in relation to FIG. 5.

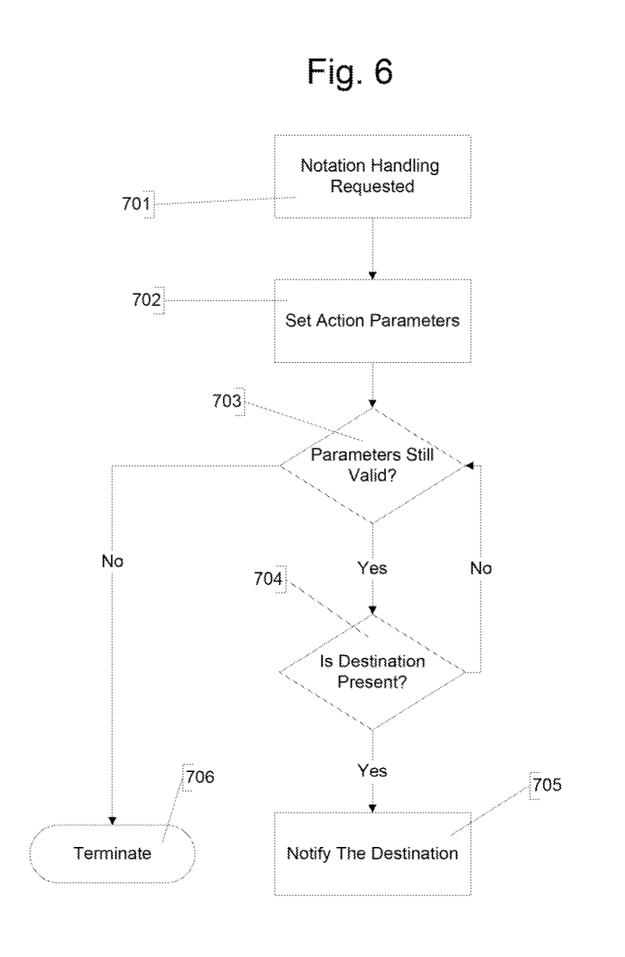

Optionally, the caller may leave a notation, such as a “missed call” standard notification (504), which includes the caller's phone number. This is described in relation to FIG. 6.

FIG. 5 describes handling a future (deferred) call, performed after a previously unavailable destination has become available to receive a call.

The steps of the process are: The web server receives an action request to initiate a call at a future time when the destination becomes available (601). The web server sets the parameters for action (602), such as an expiration time after which the destination will no longer be checked for availability. If the action parameters are still valid (603), then the destination's availability is checked (604). If the destination is available, then the caller's availability is checked (605). If both are unavailable (604,605) then the loop continues until they are both available or the action parameters are no longer valid. If the parameters are not valid the process is terminated (609). If both are available, then the caller is notified (606). If the caller opts to call the destination (607), the call is routed to the cellular network (608), and the call is initiated. If not, the process terminates (609).

FIG. 6 describes delivery of a notation to a destination that a caller tried to reach the destination. The notation may take the form of a standardized “missed call” notification, an individualized text message, or a visual icon message.

The steps of the process are: The web server receives an action request from a caller, to handle a notation (701). Web server sets the parameters for action (for example: expiration time) (702). If the parameters are still valid (703) then the destination presence within the range of the cellular network, is checked (704). If the destination is not present then the loop (704-703) continues until the parameters are no longer valid or until the destination becomes present (703). If the parameters are not valid then the process is terminated (706).

If the destination is present (704) then a notification (such as a text message, a standardized sound message or a visual icon of a missed call) are sent to the destination (705).

FIG. 7 describes leaving a voice message for an unavailable destination.

The steps of the process are: The web server receives an action request to leave a voice message (801). The caller records a voice message on the web server (802). The web server checks if the destination is present in the range of the cellular network (803). If some time has passed and the destination still is not present and the message has become irrelevant, the caller can delete the message (804) and the process ends (805). If the caller did not delete the message, the loop continues until the destination is present (803) or the caller deletes the message.

If the destination becomes present (803) the web server notifies the destination that a message is waiting (806). When the destination user listens to the message (807) the web server sends a notification to the caller (808).

If a voice message is no longer relevant and has not yet been retrieved, the caller can choose to delete a message he has left, or can replace the message with a new message.

Optionally, a user waiting to receive a particular phone call, knowing that he will soon be unavailable, or out of range, may record a voice message to be played to the particular caller when the call is received.

Cellular users in particular locations suffer from areas without coverage. This results in premature disconnection of a call when the user leaves a cell area and is not properly handed off to another cell. In one embodiment of the invention, the software application installed on the handset recognizes a prematurely terminated call, by identifying when a call ended without a user pressing an “end call” button. The application then sends an update of the presence and availability status of the cellular handset, to the server, and queries the caller whether he is interested in redialing the destination. If so, the server will check whether both users are present and available, and a call will be dialed using the cellular handset's dialer and the cellular network. If one of the users is not present or available within a predetermined time, the caller will be informed, and queried whether he wishes to be informed when the user becomes available at a later time.

One aspect of the invention, allows use of the software and system of the invention, in order to identify two users that are presently available and have a common interest. For instance, instead of a homeowner wasting time calling a long list of repairman till they locate one available to perform the repair today, they could request the server to identify a subscribing repairman available and located in the vicinity, and to connect a call to the repairman. Similarly, a driver with a flat tire at the side of the highway can request the server to immediately call a repairman that the server identifies as available and nearby.

Each subscriber, upon registration, defines his profile using the software of the invention, including one or more general parameters such as: profession, fields of interest, physical address, age, gender, current location, time, profession, sports, dating preferences, social activities, etc. Subscribers can then locate and be connected by cellular phone, to new people based on their profile definitions. The resultant social network increases traffic over cellular networks. After a user downloads the software application to his cellular phone, and registers, the server will periodically be updated as to the user's whereabouts and availability, allowing other users to receive availability information.

Examples for use of the invention for connecting two previously unknown phone users include: to form carpools, social groups, movie clubs, sports teams, dating, and to locate business service providers.

The web server can save historical call data and user definitions, generate ad-hoc personal reports and statistical analysis.

Each subscriber's profile contains two types of parameters:
1. General Profile parameters- such as fields of interest, service providing ability, address, etc. (as mentioned hereinabove). These parameters typically remain constant for at least several months.
2. Dynamic ad-hock parameters—such as a user's present location or availability on a given date, or his interest in receiving networking phone calls between specific times. For instance, a user would like to network and provide/receive a business service today; or a user would like to receive dating phone calls only after working hours.

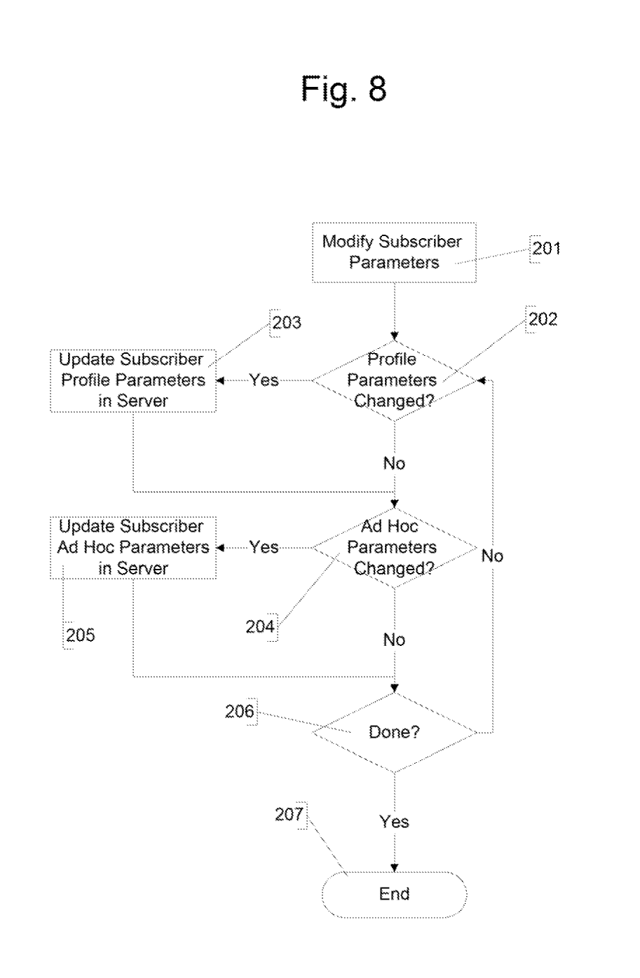

FIG. 8 describes registering a subscriber's profile parameters on the server, for social networking using the invention.

The steps of the process are: The subscriber can modify his own parameters (201). If his general profile parameters changed (202) then parameters are updated on web server (203). If his ad-hoc parameters changed (204) then these parameters are updated on the web server (205). If the updating is done (206) the process ends (207). If not, the loop continues (202).

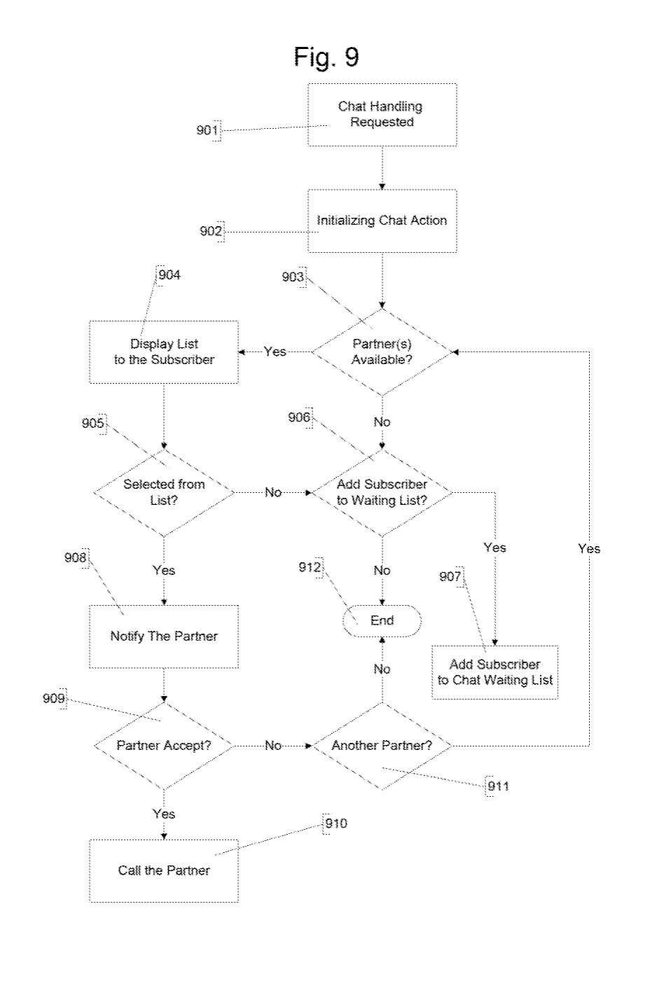

FIG. 9 describes matching between two subscribers with a common goal or interest, which ends in a cellular phone call between the users.

The steps of the process are: A phone call conversation (termed “a chat”) is requested by a subscriber (901). The Web server initiates a cellular voice conversation (chat action) according to the subscribers profile and his ad-hoc parameters. The web server checks if there is a partner(s) available with mutual interests on the subscriber waiting list (903). A list of available partners is displayed to the subscriber (904). If the subscriber selects a partner from the list (905), then the partner is notified (908). If the partner accepts (909) a call is initiated and the cellular phone call takes place (910). If the partner does not accept, the caller can opt to select another partner (911). If a subscriber chooses not to select another partner the process ends (912). If the subscriber opts to select another partner, the process returns to step (903). If there is no partner presently available (903) or no partner which matches the profile parameters, on the list (905) the subscriber can opt to add himself to a waiting list (906). The web server adds the subscriber to the waiting list (907). If the subscriber declines to be added to a waiting list, the process ends (912).

In summary, the invention is thus useful for maximizing the revenues and efficiency of cellular phone networks, by ensuring a maximum of completed calls. The invention lowers the overload on the cellular network, and only allows initiation only of calls that can be completed. Additionally, the invention allows efficient networking between subscribers that are available and interested in such networking.

Having described the invention with regard to certain specific embodiments thereof, it is to be understood that the description is not meant as a limitation, as further modifications will now become apparent to those skilled in the art, and it is intended to cover such modifications as are within the scope of the appended claims.

1. A method for determining the presence and availability of a cellular phone destination, comprising:
a) maintaining a web server for monitoring the cellular phone presence and availability status of a plurality of subscribing users;
b) registering a user as a subscribing user;
c) receiving periodic updates of presence and availability status from at least one subscribing user, and saving said updates upon said web server, the subscribing user having been equipped with a software application for periodically updating a web server with the subscribing user's cellular phone presence and availability status;
d) upon user request for performing a phone call between cellular phones, determining whether the destination cellular phone is a registered user and is present and available, from the updated presence and availability status;
e) performing a cellular phone call if the destination is present and available; and allowing a user to select an action if the destination is not present or is unavailable.

2. The method of claim 1, wherein in step (f), the action that may be selected if said destination is not present or is unavailable, is informing said user when the destination becomes available.

3. The method of claim 1, wherein in step (f), the action that may be selected if said destination is not present or is unavailable, is recording a voice message for delivery to the destination.

4. The method of claim 1, wherein in step (f), the action that may be selected if said destination is not present or is unavailable, is delivering a notification for delivery to the destination.

5. The method of claims 4, wherein said notification is selected from: a text message, a standardized sound message, or a visual icon of a missed call.

6. The method of claim 1, wherein said step (b) of registering a user further comprises registering a user's profile for networking, and comprising an additional step performed before step (e), of allowing a user to request to match his profile to another user's profile, and to receive the phone number of a matched available user.

7. The method of claim 6, wherein said user profile includes one or more of the following: profession, fields of interest, physical address, age, gender, current location, time, profession, sports, dating preferences, and social activities.

8. The method of claim 6, wherein said networking comprises forming of: carpools, social groups, movie clubs, sports teams; for the purpose of dating, and for locating business service providers.

9. The method of claim 1, wherein said software application is adapted to recognize a prematurely terminated call, and to initiate a call to the destination when the destination and caller are both present and available.

10. A system for determining the presence and availability of a cellular phone destination, comprising:
a) a web server running software for registering a subscribing user and for monitoring the cellular phone presence and availability status of a plurality of subscribing users;
b) a software application for a cellular phone, for periodically updating a web server with the subscribing user's cellular phone presence and availability status;
c) wherein, upon receiving a user request for performing a phone call between cellular phones, said server is adapted to: determine whether the destination cellular phone is a registered user and is present and available, from an updated presence and availability status; perform a cellular phone call if the destination is available; and allow a user to select an action if the destination is not present or unavailable.

11. The system of claim 10, wherein said software (a) for registering a subscribing user comprises software for registering a user's profile for networking, and said web server allows a user to request to match his profile to another user's profile, and to receive the phone number of a matched available user.

12. The system of claim 11, wherein said networking comprises forming of: carpools, social groups, movie clubs, sports teams; for the purpose of dating, and for locating business service providers.

13. The system of claim 11, wherein the web server is maintained externally to a cellular network infrastructure.
